(19) United States
(12) Patent Application Publication
(10) Pub. No.: US 2004/0209985 A1
(43) Pub. Date: Oct. 21, 2004

(54) Resin composition for injection molding

(75) Inventor: Woei-Min Tsai, Taipei (TW)

Correspondence Address: BACON & THOMAS, PLLC, 625 SLATERS LANE, FOURTH FLOOR, ALEXANDRIA, VA, 22314

(73) Assignee: Woei-Min Tsai, Taipei (TW)

(21) Appl. No.: 10/418,164

(22) Filed: Apr. 18, 2003

(51) Int. Cl. C08K 3/26; C08K 3/40

(52) U.S. Cl. 524/425; 524/494

(57) ABSTRACT

Modified poly (ethylene terephthalate) for injection molding can be obtained by adding polycarbonate resin (PC), acrylnitrile butadiene styrene reisn (ABS), styrene butadiene styrene resin (SBS) or styrene ethylene butylene styrene resin (SEBS) into reused or recycled PET bottles. Weight percentages of these components are described in the specification.

### BACKGROUND OF THE INVENTION

1. Field of the Invention

The present invention relates to a resin composition for injection molding, and particularly to a resin composition suitable for injection molding and manufactured from recycled reground scraps of poly (ethylene terephthalate) (PET) bottles.

2. Related Prior Art

It's well known that linear polyester, for example, poly (ethylene terephthalate), has excellent physical properties in crystallization, such as heat stability. However, it is very difficult to mold this resin in the traditional way. The unmodified PET resin can only be manufactured as product with low impact resistance because of slow crystallization and hardening thereof during injection molding. In order to initiate crystallization of the PET resin, high temperature processes are necessary. Such processes are inconvenient, expensive and difficult in operation. Moreover, in a long-term molding cycle, these processes may result in serious degradation of the polymer in the high temperature cavity of the injection molding machine. Additionally, the unmodified PET resin can easily to plug the injection nozzle, which does not facilitate commercialization.

Therefore, it is desirable to provide an improved resin composition suitable for injection molding to mitigate and/or obviate the aforementioned problems. The present invention particularly provides a composition which includes reground PET scraps in order to increase the reuse rate of PET resin.

### SUMMARY OF THE INVENTION

The present invention provides a resin composition for injection molding, which includes recycled PET resin and does not plug the injection nozzle during injection molding.

The present invention also provides a resin composition for injection molding, which includes recycled PET resin and can be molded at a general injection temperature. The resin composition of the present invention includes recycled PET resin and can be molded in usual injection machines without additional modification.

The resin composition for injection molding of the present invention includes (A) 5-30 wt % of polycarbonate resin (PC), (B) 3-25 wt % of acrylnitrile butadiene styrene resin (ABS), (C) 0-10 wt % of styrene butadiene styrene resin (SBS) or styrene ethylene butylene styrene resin (SEBS), and (D) 50-90 wt % of reground PET scraps.

### DETAILED DESCRIPTION OF THE PREFERRED EMBODIMENTS

The injection molding composition of the present invention includes (A) 5-30 wt % polycarbonate resin, (B) 3-25 wt % ABS resin, (C) 0-10 wt % SBS resin or SEBS resin, and (D) 50-90 wt % reground PET scraps.

The resin composition of the present invention is suitable for any injection molding machine for which no modification is required. In addition, the resin composition of the present invention can be molded at traditional injection molding temperatures.

The reground PET scraps used in the present invention are not restricted, for example, used or recycled reground PET scraps of soda water bottles. The polycarbonate resin and ABS resin are also not restricted, for example, those used or recycled.

The polycarbonate resin of the present invention is usually ranged from 5 wt. % to 30 wt %, and preferably from 10 wt % to 20 wt %. The reground PET scraps of the present invention is usually ranged from 50 wt % to 90 wt %, and preferably from 70 wt % to 80 wt %.

The composition for injection molding of the present invention can further include glass fiber, talc, calcium carbonate or mica to form a reinforced plastic. A synthetic rubber technique can also be applied to reform the composition. In addition, the composition can be injection molded at about 450° F., so that biodegradable plastic material can be made by blending the resin composition of the present invention and one or more of other biodegradable plastic materials.

The composition for injection molding of the present invention can include additives, optionally, for example, softener, plasticizer, lubricant, anti-oxidant, UV absorbent, flame retardant, anti-static agent, pigment, dye, and other traditional additives used in a composition for injection molding.

The composition of the present invention can be prepared or molded according to many traditional methods. For example, melting and blending all contents of the composition in a single screw extruder, and then pelletizing the extruded composition. The extruded pellets can then be molded by the traditional injection molding machine.

In order to illustrate the present invention, the following examples are described in detail.

### EXAMPLE 1

Polycarbonate resin (15 g), ABS resin scraps (5 g), SBS resin (5 g) and reground PET scraps (75 g) are pre-mixed in a blender to obtain the composition of the present invention. The composition is then extruded and pelletized to obtain pellets of the present invention.

### EXAMPLE 2

Polycarbonate resin (25 g), ABS resin scraps (3 g), SBS resin (3 g) and reground PET scraps (69 g) are pre-mixed in a blender to obtain the composition of the present invention. The composition is then extruded and pelletized to form pellets of the present invention.

### EXAMPLE 3

Polycarbonate resin (5 g), ABS resin scraps (20 g) and reground PET scraps (75 g) are pre-mixed in a blender to obtain the composition of the present invention. The composition is then extruded and pelletized to form pellets of the composition of the present invention.

### EXAMPLE 4

Polycarbonate resin (6 g), ABS resin scraps (3 g), SBS resin (2 g) and reground PET scraps (89 g) are pre-mixed in a blender to obtain the composition of the present invention. The composition is then extruded and pelletized to form pellets of the composition of the present invention.

In the above given examples, the polycarbonate resin is Lexan 141 produced by GE Plastic Company; ABS resin scraps is Cyclolac T produced by GE Plastic Company; SBS resin is Kraton of Shell company; and reground PET scraps are recycled scraps of PET bottles purchased from Pure Tech Co. and randomly sampled.

About the source of the composition of the present invention, polycarbonate can be virgin or reground scraps. The reground material includes Lexan 121 and Lexan 141produced by GE Plastic Company. The ABS resin can be virgin or reground scraps. The purpose of adding of SBS or SEBS is to increase ductility of the plastic end items. Considering the cost, contents of SBS and SEBS are usually added at less than 10%.

In order to achieve a better result for the present invention, the melt index of the recycled PC can be controlled between 10 and 16, the melt index of recycled ABS resin is kept between 2 and 5.

When a smaller extruder (1.5 inches, L/D: 32/1, 4-staged heating) is used in processing the composition of the present invention, the processing temperatures are 510° F. (entrance), 490° F., 470° F. and 460° F.

When an extruder (4.5 inches, L/D: 32/1, 2-staged mixing, 10-staged heating) is used in mass production of the composition of the present invention, the temperatures are 470° F. (entrance), 490° F., 510° F., 500° F., 490° F., 480° F., 470° F., 460° F., 460° F. and 460° F.

Both of the above extruders are provided with exhaust outlets. If no exhaust outlet is equipped, the PET has to be dried at 220° C. for 6 hours before used and the transparent PET resin becomes an opaque solid.

The extruding speed, horsepower, dimension of pelletized and shape, size of extruder's opening and cooling temperature are not relative to effect of the present invention.

For the smaller extruder, pelletizing after drawing is carried out at water temperature 75-100° F. For the larger extruder, pelletizing at extruder head is carried out at water temperature 100-120° F.

In the present invention, a novel composition of amorphous type is provided by adding other resins in PET resin. Such solution is very different from the traditional compositions which were intended to increase the crystallization ability of the PET.

The modified resin composition of the present invention shows no plugging occurring after hundreds operations of injection molding, even though operated by an inexperienced worker. Conversely, the nozzle is always plugged when the unmodified PET is applied.

In the present invention, the PET resin can be further reformed to biodegradable plastic material by decreasing operating temperature thereof from 510° F. to 450° F. Since the additives used in biodegradable plastic material can sustain 450° F. only, the unmodified PET cannot be applied because of the higher melting point over 500° F.

The present invention provides a resin composition including PET for which no special condition or additional treatment is required. In addition to PC, ABS, PET, SBS (or SEBS), other additives such as glass fiber, can be selected optionally for more general application.

Although the invention is illustrated and described herein, it is nevertheless not intended to be limited to the details shown, since various modifications may be made therein without departing from the invention and within the scope and range of equivalents of the claims.

What is claimed is:

1. A resin composition for injection molding, comprising:
(A) 5-30 wt % of polycarbonate resin;
(B) 3-25 wt % of acrylnitrile butadiene styrene resin; (C) 0-10 wt % of styrene butadiene styrene resin or styrene ethylene butylene styrene resin; and
(D) 50-90 wt % of poly (ethylene terephthalate) resin.

2. The resin composition as claimed in claim 1, which further comprises a softening agent.

3. The resin composition as claimed in claim 1, which further comprises at least one reinforcing agent selected from glass fiber, talc powders, calcium carbonate and mica.

4. The resin composition as claimed in claim 1, wherein said PET resin is reused or recycled reground PET scraps.

5. The resin composition as claimed in claim 1, wherein said polycarbonate resin is selected from reused or recycled polycarbonate resin.

6. The resin composition as claimed in claim 1, wherein said ABS resin is selected from reused or recycled ABS resin.

7. The resin composition as claimed in claim 1, wherein said polycarbonate resin is 10-20 wt %.

8. The resin composition as claimed in claim 1, wherein said PET resin is 70-80 wt %.

9. A synthetic rubber composition, which comprises the resin composition as claimed in claim 1 and one or more of other synthetic rubbers.

10. A biodegradable plastic material, which comprises the resin composition as claimed in claim 1 and one or more of other biodegradable plastic materials.
